(19) United States
(12) Patent Application Publication
(10) Pub. No.: US 2008/0220780 A1
(43) Pub. Date: Sep. 11, 2008

(54) Method for the automatic calibration of location anchors

(75) Inventors: Steve D. Huseth, Plymouth, MN (US); Andrew G. Berezowski, Wallingford, CT (US)

Correspondence Address: Attorney, Intellectual Property;Honeywell International Inc., 101 Columbia Rd., P.O. Box 2245, Morristown, NJ, 07962, US

(73) Assignee: Honeywell International Inc.

(21) Appl. No.: 11/715,797

(22) Filed: Mar. 7, 2007

(51) Int. Cl. H04Q 7/20

(52) U.S. Cl. 455/436

(57) ABSTRACT

A target radio can be located and tracked by an array of anchor radios. The anchor radios are calibrated when each anchor radio transmits an anchor message that is received by the other anchor radios. The distance between anchor radios is known because their positions are known. The received signal strengths are dependent on distance and an attenuation value. The calibration operation uses the received signal strengths and known anchor radio locations to determine the attenuation values of the anchor radios. After calibration, a target radio transmission can be received by the anchor radios. Each anchor radio estimates the distance to the target. The distance estimates and the anchor locations can then be used to determine the target radio's location.

### TECHNICAL FIELD

Embodiments relate to radios, radio location, item locating, and item tracking. Embodiments also relate to distance estimation, triangulation, and radio tracking.

### BACKGROUND OF THE INVENTION

Radios have long been used for locating and tracking people, items, and animals. With the advent of the global positioning system (GPS), tracking and locating within many environments has become much easier. Other environments, such as inside of buildings, pose difficulties for GPS type solutions. Building interiors, furthermore, often require a level of availability and precision that is unavailable from GPS.

Advanced location techniques, such as time-of-flight or time-difference-of-arrival can be used when sufficiently accurate clocks and synchronization are available. Other, less costly techniques use the property that radio signals usually attenuate at a near constant rate over distance. When a signal is transmitted at a known power level a receiving radio can estimate the distance to the transmitter.

Radio signal attenuation can be used to locate a transmitter. A group of radios can all calculate the distance to the transmitter. A location processor can then, given the location of each radio and the transmitter's distance from each radio, estimate the transmitter's location.

The local environment, however, causes hard to predict variations in radio signal propagation. The environment can also change over time. Systems and methods to address shortcomings in the prior art are needed.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

It is therefore an aspect of the embodiments that anchor radios exchange anchor messages. The anchor radios are located at known anchor locations. The anchor messages arrive at the anchor radios with anchor received signal strengths. The anchor radios can measure the anchor received signal strength of each received anchor message.

It is also an aspect of the embodiments that anchor attenuation values are determined from the anchor received signal strengths and the anchor locations. The distance between each anchor radio is known because the location of each anchor radio is known. The anchor messages can be transmitted with a known strength. As such, the anchor received signal strengths can be used to determine anchor attenuation values. The anchor attenuation values are scaling factors that can correct for environmental factors that effect the propagation of radio signals.

It is another aspect of the embodiments to receive at least two target receptions. A target can transmit a signal that is received as target receptions by two or more of the anchor radios. As such, there are as many target receptions as there are anchor radios receiving the target transmission. The anchor radios can determine the target received signal strengths of the target receptions.

It is a further aspect of the embodiments that the target received signal strengths, the anchor radio locations, and the anchor attenuation values can be used to determine the location of the target.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of the embodiments and, together with the background, brief summary, and detailed description serve to explain the principles of the embodiments.

FIG. 1 illustrates anchor radios exchanging anchor messages in accordance with aspects of the embodiments;

FIG. 2 illustrates obtaining attenuation values in accordance with aspects of the embodiments;

FIG. 3 illustrates anchor radios and a target radio in accordance with aspects of the embodiments;

FIG. 4 illustrates a high level block diagram of determining a target location in accordance with aspects of the embodiments;

FIG. 5 illustrates a location processor in accordance with aspects of the embodiments;

FIG. 6 illustrates an anchor processor in accordance with aspects of the embodiments;

FIG. 7 illustrates a high level flow diagram of determining anchor attenuation values in accordance with aspects of the embodiments; and

FIG. 8 illustrates a high level flow diagram of determining a target location in accordance with aspects of the embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

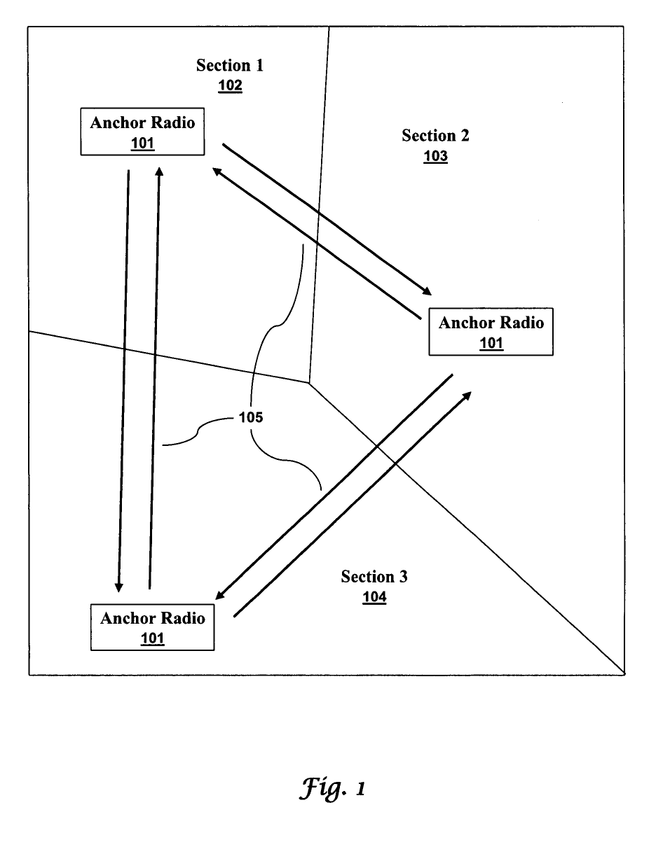

FIG. 1 illustrates anchor radios 101 exchanging anchor messages 105 in accordance with aspects of the embodiments. Three anchor radios 101 are arranged within an area having three sections. The section 1 102 anchor radio 101, the section 2 103 anchor radio 101 and the section 3 104 anchor radio send and receive anchor messages 105 with the other anchor radios 101.

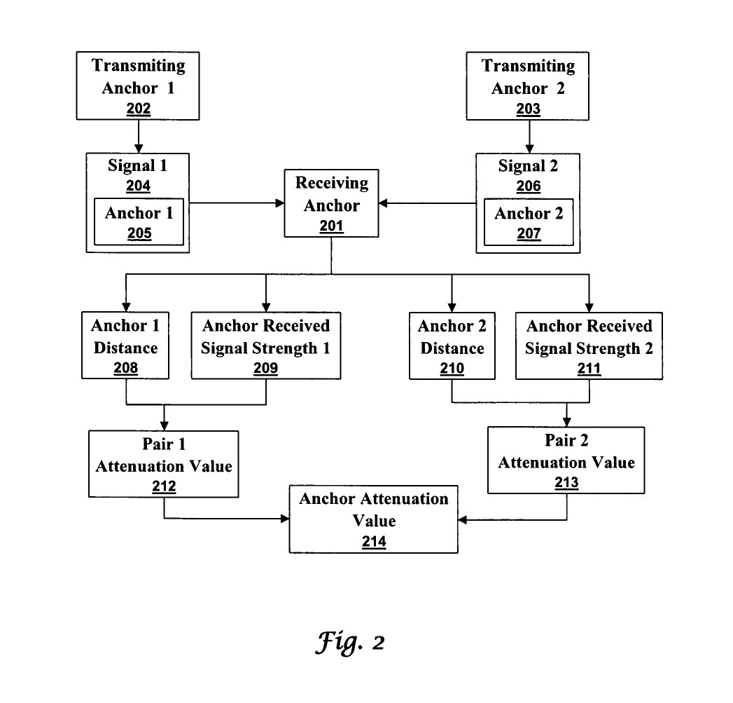

FIG. 2 illustrates obtaining attenuation values in accordance with aspects of the embodiments. A first anchor radio 202 send a first anchor message, called signal 1 204, that is received by a receiving anchor 201. Other anchors can also receive signal 1 204. The first anchor message contains an anchor 1 Id 205 so that any receiving radio can examine the message to find which radio transmitted it. Similarly, Anchor 2 203 transmits signal 2 206 containing an anchor 2 Id 207. The receiving anchor measures the anchor received signal strength 1 209 of signal 1 204 and the anchor received signal strength 2 211 of signal 2 206. The Anchor 1 distance 208 and anchor 2 distance 210, which are the distances between the receiving anchor 201 and transmitting anchors 202, 203, are known because the locations of all the anchor radios are known.

Equation 1 relates distance, attenuation, and received signal strength as:

d=C*e^{k*RSSI} (1)

where d is distance, k, the radio constant, is the rate of attenuation for the design of the radio, RSSI is the received signal strength, and C is the attenuation value. The attenuation value can be found by setting d to the anchor distance, RSSI to the anchor received signal strength, and k to the radio constant.

The pair 1 attenuation value 212 is the attenuation value found when the receiving anchor 201 receives an anchor message, such as signal 1 204, from transmitting anchor 1 202. The pair 2 attenuation value 213 is the attenuation value found when the receiving anchor 201 receives an anchor message, such as signal 2 206, from transmitting anchor 2 203. The anchor attenuation value 214 for the receiving anchor 201 can be the average of all the pair attenuation values.

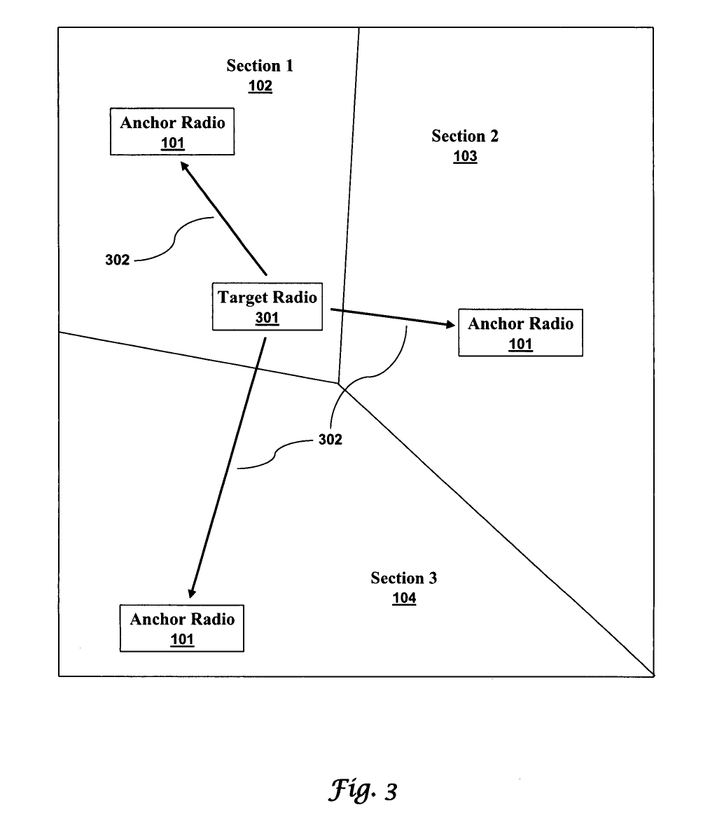

FIG. 3 illustrates anchor radios 101 and a target radio 301 in accordance with aspects of the embodiments. The target radio 301 can transmit a signal 302 that is received by three anchor radios 101. Section 1 102, section 2 103, and section 4 104 are each illustrated as containing a single anchor radio. Buildings, fields, or other areas can be divided into sections and anchor radios can be placed in the sections. A section can contain multiple anchor radios or no anchor radios at all.

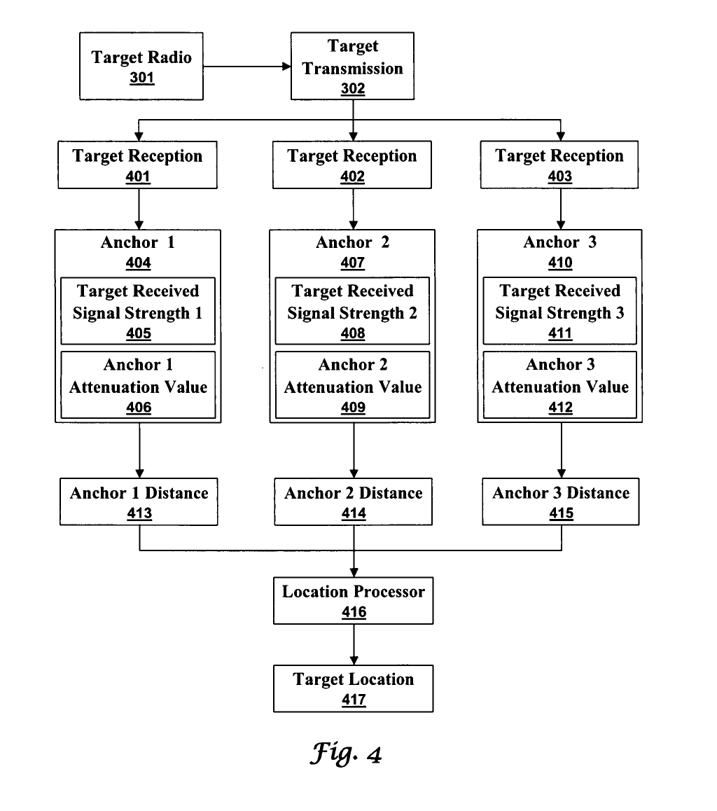

FIG. 4 illustrates a high level block diagram of determining a target location 417 in accordance with aspects of the embodiments. The target radio 301 sends a target transmission 302 that is received as target receptions by anchor radios. Anchor 1 404 receives the target transmission 302 as target reception 1 401 and determines target received signal strength 1 405. Anchor 2 407 receives the target transmission 302 as target reception 2 402 and determines target received signal strength 2 408. Anchor 3 410 receives the target transmission 302 as target reception 3 403 and determines target received signal strength 3 411.

Equation 1 can be used to find the anchor distances. The anchor 1 distance 413 is the distance from anchor 1 404 to the transmitting radio 301. The anchor 2 distance 414 is the distance from anchor 2 407 to the transmitting radio 301. The anchor 3 distance 415 is the distance from anchor 3 410 to the transmitting radio 301. A location processor 416 can use the anchor distances along with the known anchor positions to estimate the target locations 417. Those practiced in the art of surveying know how to triangulate by taking the distances from two known points to accurately find the location of a third point. Those practiced in the art of triangulation also know how to use the distance from three or more points to find the location of another point and to also to determine a location error.

One way of determining the target location is to minimize the location error as expressed by the following equation:

$$E = {\sum }_{i = 1}^{N} {( dist ( {A}_{i} , T ) - {d}_{i} )}^{2} \qquad ( 2 )$$

where E indicates the location error, Aᵢ is the location of the i^{th} anchor radio, T is the target location, dᵢ is the distance found from the received signal strength, and dist(a,b) is the distance between two points, a and b. The target location, T, is the location that results in the smallest value of E. In a perfect case, the minimum location error is zero. Various conditions, such as incorrect anchor locations or anchor attenuation values, can lead to a location error greater than zero. As such, an excessive location error can indicate that recalibration is necessary to determine new attenuation values. Those practiced in numerical algorithms know of many ways to find the minimum of equations.

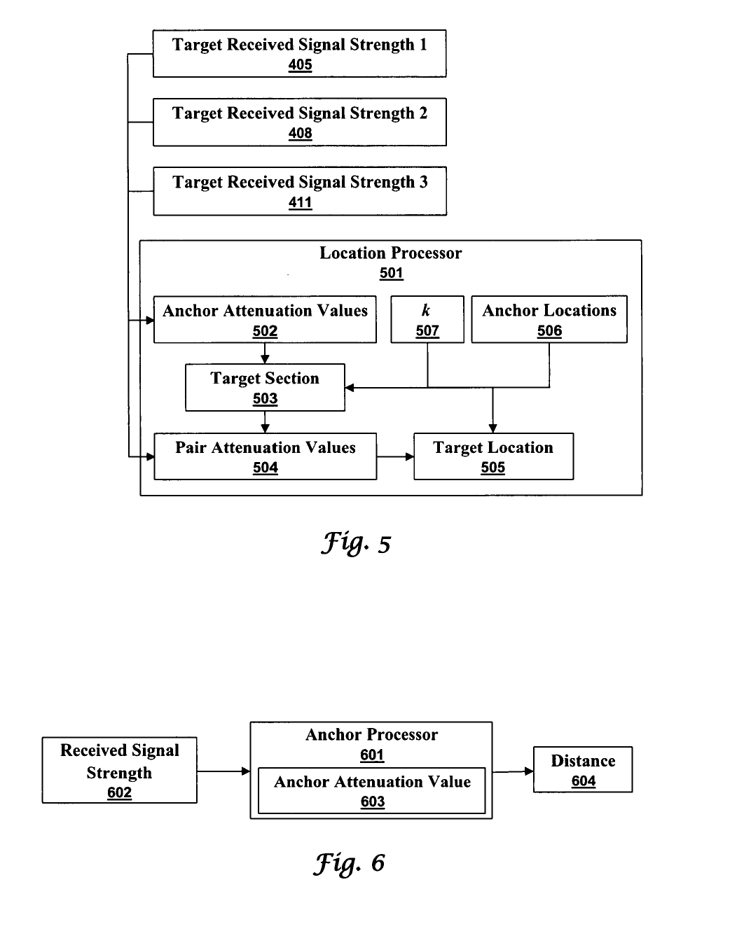

FIG. 5 illustrates a location processor 501 in accordance with aspects of the embodiments. That anchor locations 506 and the anchor attenuation values 502 can be stored in the location processor. Here, the radio constant k 507 is explicitly shown for completeness because it is not a universal constant, like e, but is otherwise well known within the context of the embodiments and used in equation 1. The location processor 501 accepts the received signal strengths 405, 408, 411 and uses them to determine a first location estimate. The first location estimate can be used to determine the target section 503, which is the section containing the target radio.

Recall that an attenuation value can be the average of pair attenuation values as shown in FIG. 2. The pair attenuation values 504 can be considered as precise attenuation values that can be used when the target is in a known target section. The location processor 501, having determined the target section 503, then uses the pair attenuation values 504 to determine the target location 505. A target location 505 determined from pair attenuation values 504 should be more accurate than that calculated using anchor attenuation values 502.

For example, In FIG. 3 the target radio is located in section 1. A location processor can use the anchor attenuation values to find that section 1 contains the target radio. Recalling FIG. 2, consider the case where the section 3 anchor radio is the receiving anchor and the section 1 anchor radio is transmitting anchor 1. In this case, the pair 1 attenuation value can be used in equation 1 to more precisely determine the distance from the section 3 anchor radio to the target. A similar pair attenuation value can be used to determine the distance from the section 2 anchor radio to the target. The section 1 anchor radio can simply use the anchor attenuation value to determine the distance to the target. As such, pair attenuation values can be used in equation 1 to calculate more precise distance estimates. The more precise distance estimates can then be used in equation 2 to calculate a more precise position estimate.

Sections can be defined explicitly, as diagramed by FIGS. 1,3 or they can defined implicitly. Sections can be implicitly defined by minimum distance to an anchor radio. The anchor radios 101 receive a transmission from the target radio 301. Target distances are calculated using the anchor attenuation values and equation 1. The minimum distance determines the section. For example, if the minimum distance is between the section 2 anchor radio 101 and the target radio 301, then the target radio 301 is in section 2.

FIG. 6 illustrates an anchor processor 601 in accordance with aspects of the embodiments. An anchor radio can contain an anchor processor 601 that accepts a received signal strength 602 and calculates a distance 604. The distance 604 can then be passed to a location processor. The anchor processor is illustrated as explicitly containing an anchor attenuation value 603. The anchor processor could also contain the radio constant if it explicitly solved equation 1. If however, another method was used for calculating distance such as a lookup table, interpolation, or polynomial approximation, then the radio constant could be implicitly contained as part of the calculation method.

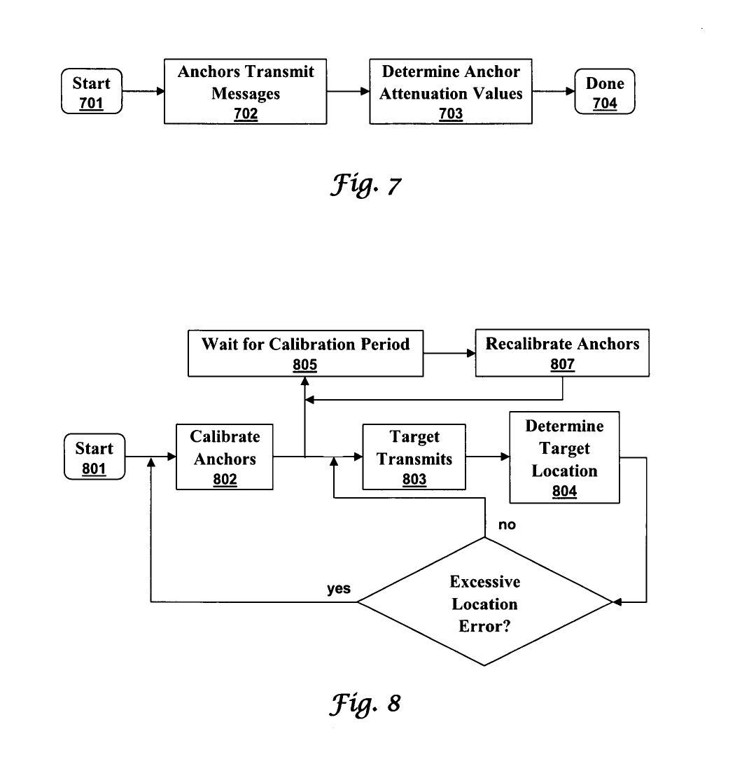

FIG. 7 illustrates a high level flow diagram of determining anchor attenuation values in accordance with aspects of the embodiments. After the start 701, the anchor radios transmit messages 702. The anchor radios receive each other's messages and use them along with their known locations to determine anchor attenuation values 703 before the process is done 704. The process of FIG. 7 calibrates the anchor radios so that they can accurately determine target locations.

FIG. 8 illustrates a high level flow diagram of determining a target location in accordance with aspects of the embodiments. After the start 801, the anchors are calibrated 802 as detailed in FIG. 7. At this point, the flow splits into two concurrent branches. In one branch, the process waits for a period of time 805 and then recalibrates the anchors 807 and returns to waiting 805. In the other branch, the target radio transmits 803 resulting in target receptions at the anchor radios. The target location is then determined 804. The location error is then examined 806 and, if excessive the process loops back to calibrate the anchors 802. Otherwise, more target locations are determined. Alternatively, an anchor radio can act as a target radio and transmit 803 such that its location is found 804. The error in this case, the anchor error, is the difference between the estimated and known locations of the transmitting anchor radio. Excessive anchor error can trigger recalibration.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

Having thus described the invention what is claimed is:

1. A method comprising:
exchanging at least two anchor messages between at least two anchor radios wherein the anchor radios have anchor locations and wherein the anchor messages have anchor received signal strengths;
determining at least two anchor attenuation values from the anchor locations and the anchor received signal strengths wherein the anchor attenuation values are uniquely associated with the anchor radios;
receiving at least two target receptions wherein a target transmits a signal that is received by at least two of the anchor radios and wherein each target reception has a target received signal strength; and
determining a target location from the target received signal strengths, the anchor attenuation values, and the anchor locations.

2. The method of claim 1 further comprising:
periodically exchanging anchor messages between the anchor radios; and
determining new anchor attenuation values to thereby automatically compensate for changing conditions.

3. The method of claim 1 further comprising calculating a target error value from the target received signal strengths, the anchor attenuation values, and the anchor locations.

4. The method of claim 1 further comprising:
calculating a location error;
determining that new anchor attenuation values are needed;
exchanging anchor messages between the anchor radios; and
determining new anchor attenuation values.

5. The method of claim 1 further comprising:
determining at least two target distances wherein each anchor radio determines one of the target distances from the target received signal strengths and the anchor attenuation values; and
passing the target distances to a location processor wherein the location processor determines the target location from the target distances and the anchor locations.

6. The method of claim 1 further comprising passing the target received signal strengths to a location processor wherein the location processor determines the target location from the target received signal strengths, the anchor attenuation values and the anchor locations.

7. The method of claim 1 further comprising:
calculating an anchor error;
determining that a new anchor attenuation value is needed;
determining new anchor attenuation values.

8. A method comprising:
exchanging at least two anchor messages between at least two anchor radios wherein the anchor radios have anchor locations, wherein the anchor messages have anchor received signal strengths, and wherein the anchor radios are located in at least two sections;
determining a multiplicity of pair attenuation values from the anchor locations and the anchor received signal strengths wherein each pair attenuation value is uniquely associated with a pairing comprising one of the anchor radios and one of the sections;
determining at least two anchor attenuation values from the anchor locations and the anchor received signal strengths wherein the anchor attenuation values are uniquely associated with the anchor radios;
receiving at least two target receptions wherein a target transmits a signal that is received by at least two of the anchor radios and wherein each target reception has a target received signal strength;
determining a target section from the target received signal strengths, the anchor attenuation values, and the anchor locations; and
determining a target location from the target received signal strengths, the pair attenuation values, and the anchor locations.

9. The method of claim 1 further comprising:
periodically exchanging anchor messages between the anchor radios; and
determining new anchor attenuation values to thereby automatically compensate for changing conditions.

10. The method of claim 1 further comprising calculating a target error value from the target received signal strengths, the anchor attenuation values, and the anchor locations.

11. The method of claim 1 further comprising:
calculating location error;
determining that new anchor attenuation values are needed;
exchanging anchor messages between the anchor radios; and
determining new anchor attenuation values.

12. The method of claim 1 further comprising:
determining at least two target distances wherein each anchor radio determines one of the target distances from the target received signal strengths and the anchor attenuation values; and
passing the target distances to a location processor wherein the location processor determines the target location from the target distances and the anchor locations.

13. The method of claim 1 further comprising passing the target received signal strengths to a location processor wherein the location processor determines the target location from the target received signal strengths, the anchor attenuation values and the anchor locations.

14. The method of claim 8 further comprising:
calculating an anchor error;
determining that a new anchor attenuation value is needed;
determining new anchor attenuation values.

15. A system comprising:
at least two anchor radios wherein the anchor radios have anchor locations;
at least two anchor receptions wherein each one of the anchor receptions is received by one of the anchor radios after being transmitted by another of the anchor radios and wherein each anchor reception has an anchor received signal strength;
at least two anchor attenuation values uniquely associated with the anchor radios and determined from the anchor locations and the anchor received signal strengths;
a target transmitter that transmits a target transmission that is received as a target reception by at least two of the anchor radios wherein each target reception has a target received signal strength; and
a location processor that determines a target location from the target received signal strengths, the anchor attenuation values, and the anchor locations

16. The system of claim 15 further comprising:
a timer that periodically triggers anchor radio transmissions that are received as anchor receptions such that the anchor attenuation values are periodically updated.

17. The system of claim 15 further comprising a target error value determined from the target received signal strengths, the anchor attenuation values, and the anchor locations.

18. The system of claim 15 further comprising:
an error value determined from received signal strengths, the anchor attenuation values, and the anchor locations wherein the anchor attenuation values are updated when the error value is excessive.

19. The system of claim 15 further comprising:
at least two anchor processors that determine at least two target distances from the target received signal strengths and the anchor attenuation values; and
a location processor that determines the target location from the target distances and the anchor locations.

20. The system of claim 15 further comprising a location processor that determines the target location from the target received signal strengths, the anchor attenuation values and the anchor locations.
